(19) United States
(12) Patent Application Publication
(10) Pub. No.: US 2024/0232729 A1
(43) Pub. Date: Jul. 11, 2024

(54) CACHE AND LEARNED MODELS FOR SEGMENTED RESULTS IDENTIFICATION AND ANALYSIS

(71) Applicant: Kayak Software Corporation, Stamford, CT (US)

(72) Inventors: Jacob Vincent Bouvrie, Arlington, MA (US); Gabriel Pelaez, Lincoln, MA (US); Giorgos Zacharia, Winchester, MA (US); Snehal Patel, Carlisles, MA (US)

(21) Appl. No.: 18/150,780

(22) Filed: Jan. 5, 2023

(51) Int. Cl. G06Q 10/02; G06N 3/08; G06Q 30/0283

(52) U.S. Cl. CPC G06Q 10/02; G06N 3/08; G06Q 30/0283; G06N 3/044

(57) ABSTRACT

Systems, methods, and computer-program products for online booking of lodging location reservations include receiving desired reservation information from a user; updating information stored in cache using a price and availability predictive machine learning model using the received desired reservation information; performing a search in the cache for solutions to the received desired reservation information; constructing all possible solutions available in the cache that satisfy the received desired reservation information, including splits in stays between more than one lodging locations; determining a score for each solution using a scoring machine learning model that considers the user's preferences; identifying a subset of solutions based on the score of each solution; performing live pricing and availability verification for the subset of solutions by querying a provider corresponding to each of the subset of solutions; and presenting the subset of solutions to the user with the verified pricing and availability information.

### BACKGROUND

Online reservations and booking have become a ubiquitous part of travel planning. Often, the total cost of a reservation is the primary factor driving the decision of a user to book, and the search engine that is able to find the lowest cost reservation(s) will prevail.

### SUMMARY

The described solution is advantageous in that it reduces queries between systems in order to make a previously infeasible search feasible. By intelligently predicting pricing and availability information ahead of time, a booking management system need not query for price and availability of every possible solution for a particular stay. Instead, only those solutions likely to yield savings and satisfy the user can be queried, resulting in a cost efficient reduction in network traffic. Additionally, by reducing the partner systems queried and the number of queries, search time can be significantly reduced.

Intelligent prediction of pricing and availability can increase the accuracy of the pricing and availability data without having to fetch pricing and availability data for each query in real-time, and without having to rely on potentially stale pricing and availability data previously stored in cache. Predictions are often computationally less taxing to the supporting infrastructure, and so could reduce substantially the systems overhead that would otherwise be necessary to obtain prices and inventory details to support the proposed use-cases. In addition, providers offering price/availability APIs incur a query cost themselves and often consider query-to-booking ratios in their partner agreements. Keeping provider query loads low and within any agreed-upon or historical ranges may be an important constraint that would be satisfied by employing predictive inventory models.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF DRAWINGS

To describe technical solutions in the implementations of the present specification or in the existing technology more clearly, the following briefly describes the accompanying drawings needed for describing the implementations or the existing technology. The accompanying drawings in the following descriptions merely show some implementations of the present specification and a person of ordinary skill in the art can still derive other drawings from these accompanying drawings without creative efforts.

FIG. 1 is a schematic diagram of an example system 100 that includes an aggregator system that uses a cache and predictive modeling in accordance with embodiments of the present disclosure.

FIG. 2 is a flowchart showing an example process for generating split bookings in accordance with embodiments of the present disclosure.

FIG. 3 is a schematic diagram of an example subsystem for performing cache updates using predictive modeling in accordance with embodiments of the present disclosure.

FIG. 4 is a process flow diagram for performing cache updates using predictive modeling in accordance with embodiments of the present disclosure.

FIG. 5 is a schematic diagram of an example subsystem for constructing and scoring solutions in accordance with embodiments of the present disclosure.

FIG. 6 is a process flow diagram for constructing and scoring solutions and presenting solutions to a user in accordance with embodiments of the present disclosure.

FIG. 7 is an example architecture for a system for generating split stays automatically.

Like reference numbers and designations in the various drawings indicate like elements.

### DETAILED DESCRIPTION

This disclosure describes a system for performing mixed queries for booking lodging location stays, including hotel stays, rental homes, bed-and-breakfasts, rental rooms, or other forms of temporary lodging. A consumer can discover savings in hotel bookings by booking parts of their stay with different providers. A mixed query is where a particular stay is split amongst multiple bookings. Conventional lodging search services, in response to a user query (or in connection with a user's flight inquiry) report the best available prices for lodgings for the whole stay of the user. For example, if a traveler is staying in Chicago from May 13 through May 17, lodging search services conventionally return the best price for respective lodgings over the full span of the stay. However, the price returned from a query over the whole stay may not be the least expensive option. A better price might be achieved by searching over smaller time periods within the target stay dates. For example, the cheapest rate returned for the May 13-May 17 Chicago trip at a particular hotel might be $700/night, but Booking.com offers $500/night for May 13-May 15 and Orbitz.com offers $400/night for May 15-May 17, for a total average price of $450/night. Conventional queries cannot identify this booking and the user loses out on the cost savings of the cheaper booking. However, mixed queries as described above cannot be implemented at scale with manual queries; even traditional brute force computational resources do not overcome this computationally impossible task.

In some embodiments, conventional queries can return pricing and availability information that can be used to construct split stay options. Split stay options from convention query results can be constructed using predictive algorithms, as discussed below.

Hotel price aggregators query multiple computer reservation systems to present the information to the end user. The costs of these systems are high enough that it is beneficial to engage in intelligent predictive caching such as predicting likely consumer queries using machine learning models, predicting time to expire per item in the cache, or other predictions in order to limit repetitive queries to the computer systems of the partner companies. In some situations, the costs are so significant that the revenue sharing for bookings are indexed inversely onto look-to-book ratios in an attempt to incentivize high intent queries that yield as low look-to-book ratios as possible. Hotel price aggregators can data mine their live hotel rate cache data to identify patterns of potential savings, which can be costly and time consuming given the large quantity of information available for lodging solutions. Using machine learning to predict savings and to decide which components of a mixture query need to be updated with live prices (to achieve both accuracy, but also to minimize look-to-book) can allow a hotel price aggregator to maximize revenue. The date split points, potential booking sites, and other aspects are also determined through supervised learning driven optimizations.

There are three main challenges addressed by the techniques described herein. First, the search space is large, because the number of ways to split a stay over independent bookings can be large. For example, solutions (assignments of nights to bookings) may contemplate a maximum number of bookings per stay as high as 4 or 5 or more. Additionally, the search space is large because the number of potential solutions per split is large, and all of same-hotel/same-room, same-hotel/different-room, different-hotel mixtures and combinations of bookings may be considered. Finally, room types must be matched, approximately matched, or optimized given partial, highly non-standardized data while trading off against potential savings.

Second, not every solution can be feasibly evaluated because only a relatively small number of prices and inventory can be queried without overloading partner systems or increasing the look-to-book ratio beyond a reasonable scope.

Third, not every solution is appropriate for every user. Therefore, solutions that are likely to satisfy each particular end user's goals (e.g., cost, time period, and quality) need to be identified.

Turning to the first challenge of a large search space, although the cost of exhaustively searching over all possible solutions can be prohibitive for the reasons outlined above, aggregators (and their users) benefit from considering a large space of candidate solutions so that the most compelling options with a high likelihood of being available can be identified, evaluated, and validated in real-time or near real-time.

This search covers more than all splits of a stay into two contiguous segments, but also greater numbers of segments. For example, the number of ways one can break an n-night stay into k≤n contiguous segments (bookings) is given by

$$\frac{( n - 1 )}{( k - 1 )} ,$$

where a search is performed over each k up to a reasonable maximum. For example, the number of ways to contiguously partition a 3 night stay into, at most, 3 bookings is 4. However, this number quickly grows for even common, short-stay searches: a 5 night stay split over 3 bookings has 11 possibilities (the number of 3-splits grows quadratically in the length of stay). In practice, this solution can realistically examine solutions involving more than 3 splits, particularly when the same room types in the same venues can be reserved so that the likelihood of having to vacate a room is low.

The task of matching hotel rooms is itself non-trivial, due to the mixture of amenities, freebies, discounts and conditions that can vary by hotel, room type, dates and booking provider. Moreover, each provider returns price/inventory information in their own non-standard format, with varying degrees of detail and differing nomenclature. Among the potential classes of solutions described above, splits within the same hotel over identical or comparable rooms are important because of the convenience and simplicity. For this class of solutions, it is critically important to match rooms or select the best/closest room with similar offerings, conditions, and price range. Automated evaluation of room similarity, as defined by a user, may be done by way of empirically determined heuristics, or, through more systematic optimization drawing on machine learning methods.

In this disclosure, techniques are described that allow the use of cached data for performing a wide search for solutions to user inquiries. The use of a cache allows for solutions to be constructed quickly and without incurring costs at the provider side. The cache can include information including hotels, rooms, pricing, check-in and check-out dates, the age of the information, providers of the pricing, and other pertinent information. For information that is considered stale, predictive models, such as machine learning models, can be used to estimate the pricing and availability for hotels and rooms that satisfy the user's inquiry. The predictive models facilitate the use of cache for performing searches and for constructing solutions because the predictive models can account for potentially stale information. The estimated pricing and availability is verified later in the process, so the user is given accurate information about pricing and availability. The predictive models and the use of cache to perform searches allows for a larger search to be performed and a solution set to be constructed faster and cheaper than by performing direct queries to providers for each user inquiry.

This disclosure also describes constructing the solutions that satisfy the user's inquiry, scoring the solutions using predictive models, performing live verification on a subset of the solutions, and presenting verified solutions to the user in an ordered manner (based at least in part on the scoring and verification).

At a high level, the techniques described herein include the following process:

(1) Perform a cache update using predictive models. This can be done when a user submits an inquiry for a lodging reservation or can be done “asynchronously” or periodically at set times throughout the day. Correct prices drawn from the cache with predictive models to reduce error from stale entries. The cache has a long look-back in order to cover a wide range of searches and solutions. The older the information in the long look-back cache can introduce errors since older entries may not reflect current prices. The cache can be updated on demand or periodically with more recent information as well as using predictive models that estimate availability and pricing.

(2) The process can construct all possible solutions supported by the information in the cache that is pertinent to the user's inquiry. Because the search is to the cache and not to individual providers, the search can be wider and faster. There is no need to perform queries to individual providers, which is costly both in terms of money and resources. In addition, searching cache is fast compared to performing provider queries. Thus, the user can get results faster, enhancing the user experience and increasing the likelihood of the user making a booking.

To construct the solutions, the system can apply the estimated likelihood of availability from the predictive pricing models from updated cache to each solution and (later) decide which providers to query for confirmation with machine learning models.

The system can then score the top solutions. The system can apply a threshold to identify and score top candidates while taking into account the potential user savings, and a total per-provider query budget (if any). This scoring uses some analysis of global population and specific user sensitivity to a wide range of trade-offs. Decide which (and how many) solutions are good for the user conducting the search using a machine learning model that examines the individual user's context and history. This step personalizes what is going to be shown to the user. There may be many valid options, but typically space and user attention is limited, so presenting a limited set of the most helpful, appealing options may be preferred. Personalization can use explicit preferences from user-entered information as well as inferred user preferences based on historical information from the user and/or similar users, such as past bookings. For example, a user might have loyalty to a hotel brand, may have previously booked hotels that show trends, may tolerate less inconvenience etc.

A threshold value for a score can be applied to the scored solutions. The solutions at or above the threshold value can have their pricing and availability confirmed through live queries directed to the identified providers. This live verification can be performed through API calls before presenting to the user to verify the pricing and availability. Possibly have to rescore based on live pricing. Previously best solutions might drop in score or drop off completely.

Then the system can present final options to the user based on live pricing. In this way, the user is quickly provided with actual pricing and availability based on a broad search space while only searching for live pricing and availability for a smaller subset of the available options.

Turning to the third challenge of providing only appropriate solutions to the particular user, this is assessed using a machine learning model that weighs immediate search context details and previous historical behavior. Search context can include information such as the individual user's location, browser, platform, acquisition channel, and the search parameters at hand. Previous engagement/behavioral history information can include booking clicks and revenue events and the context around those events (e.g. class, rating, style and price range of hotels previously looked at or booked), previous search engagement (e.g. preferences exhibited through filter usage; dwell time; hotel detail views), email signups, among other inputs.

To help a person skilled in the art better understand the technical solutions in the present specification, the following clearly and comprehensively describes the technical solutions in the implementations of the present specification with reference to the accompanying drawings in the implementations of the present specification. The described implementations are merely some rather than all of the implementations of the present specification. All other implementations obtained by a person of ordinary skill in the art based on one or more implementations of the present specification without creative efforts shall fall within the protection scope of the implementations of the present specification.

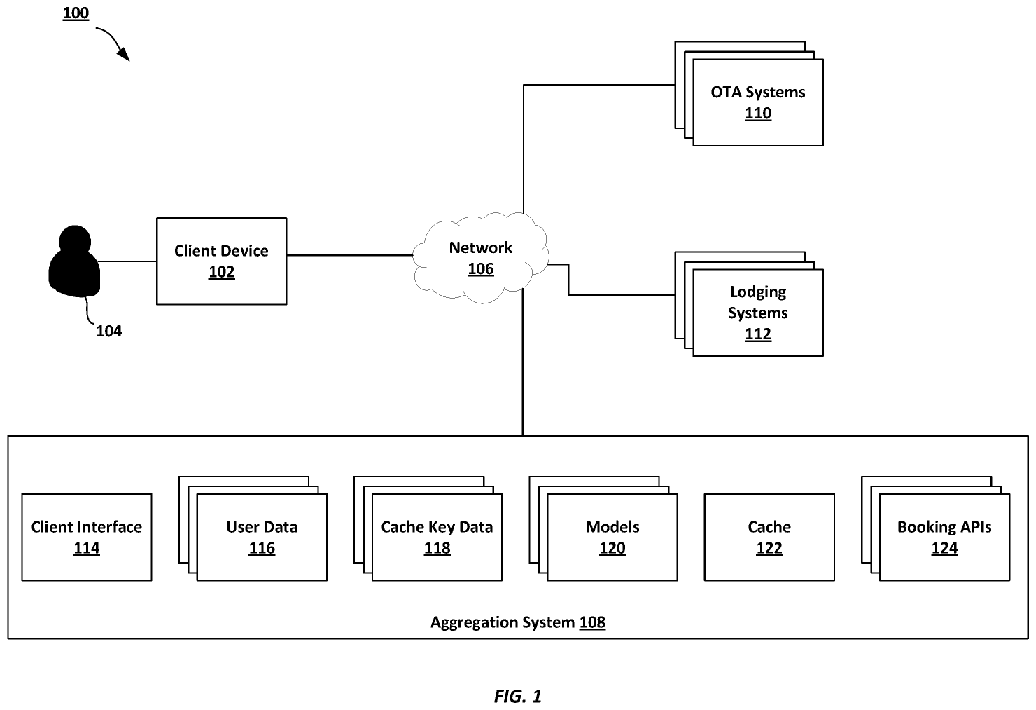

FIG. 1 is a schematic diagram of an example system 100 that includes an aggregator system 108 that uses a cache and predictive modeling to provide split stay results to a user's inquiry for a lodging reservation in accordance with embodiments of the present disclosure. The system 100 includes an aggregator system 108. Aggregator system 108 is similar to aggregator system 702 described below. Aggregator system 108 can host data aggregation processing and data processing intelligence to provide a user 104 with comprehensive and personalized results from online inquiries. Aggregator system 108 can perform queries to other networked systems, such as online databases, private servers, the Internet, or other locations to retrieve data based on a search query.

Aggregator system 108 can be accessed by a user 104 operating a client device 102 over a network 106. Client device 102 can be any type of computing device capable of communicating with other computing systems across a network 106, including but not limited to, personal computers, laptops and tablets, mobile phones, smart phones, or other computing devices. The aggregator system 108 can include or provide a client interface 114. Client interface 114 can provide a graphical user interface for the user 104 to use for searching for travel reservations, for viewing results, and for making bookings. The user 104 can also store user information 116 as part of an account the user 104 has with the aggregator system

For example, aggregator system 108 can provide a client interface 114 that allows a user to enter search terms for online travel searches, reservations, and booking. The aggregator system 108 can communicate with Online Travel Agency (OTA) systems 110 and lodging systems 112 (together referred to as “providers”) via network to retrieve lodging pricing and availability information based on a user's search queries (and also based on a user's filters, criteria, etc.). The aggregator system 108 can receive pricing and availability information for check-in and check-out dates for each hotel based on a room type from OTA systems 110 and lodging systems 112 (or other locations). The aggregator system 100 can then store the search results information in cache 122.

Aggregator system 108 includes a cache memory 122. Cache memory 122 can store data 118 for hotel pricing and availability, which is organized by cache key. In one example implementation, the cache key data 118 includes {Hotel, Room, Price, Check-in, Check-out, Provider, Observation Age}. Hotel is the name of the hotel; room is the type or quality of room; price is the (nightly or average) price of the room, check-in and check-out are dates associated with the pricing per night for the room at the hotel, provider is the travel provider offering or quoting the booking option, age is the elapsed time since observing the pricing information. Other information can also be included in the cache, such as information pertaining to the frequency that the room in the hotel is booked, which can be used to estimate whether the information is stale or not. Information in the cache 122 can be purged periodically based on the “age” of the information in the cache key. The age information also can be used by prediction models as a factor for determining the likelihood of the validity of the pricing and availability of the information in the cache key, and is a factor in price and availability correction. The cache 122 may be populated in several ways, and under several circumstances. Price and availability information retrieved based on ordinary user searches may be added to the cache throughout the day as those organic user searches occur. The cache may be populated using a predictive “priming” model, which aims to predict the searches which are likely to be requested in a future time window but which have not yet been observed within a suitable historical window. The cache may be updated with bulk updates pushed periodically through partner channels. There may be a regularly scheduled updating process which explicitly applies a model to some or all of the cache contents and updates the cache accordingly with new information generated by the model. The new information could include prices, availability, or entire estimated entries that had not been in the cache before. Such a process would benefit from “batching” together multiple model applications for computational efficiency. The cache 122 may also be populated “implicitly”, for example, in an asynchronous (“on-demand”) fashion: when a user arrives and wants to view a set of split booking options, the cache can be scanned for only those entries relevant to the user's search. The relevant entries would be fed to a price and availability prediction model, and then the output of the model would be directly used to compile split booking options, without necessarily updating the cache itself.

The aggregator system 108 also includes a plurality of models 120. Models 120 can include machine learning models, predictive models, or other algorithmic models for performing various intelligent tasks for providing split stay results to a user. For example, a first predictive model can be used to estimate the validity of pricing and availability information in the cache. By using a predictive model, the cache 122 can be used to return search results instead of searching OTA systems 110 and lodging system 112 for information. By searching cache 122 for reservations results, the search can be performed faster and using fewer resources. The predictive models use relevant data 118 in the cache 122 to estimate whether the cache data is stale or not for returning results to the user. Models 122 can also be used to process results information and return results that are satisfactory to the specific user 104. Models 122 can also be used to score and rank solutions for the specific user 104 prior to returning the information to the user 104. In general, the use of models 122 can improve the user experience by returning information faster and in an fashion best suited to the user 104; and the use of models 122 can also reduce costs and resource utilization when performing searches and providing results. The disclosure below describes how the models can be used at various points in the search procedure to provide split stays to the user.

The aggregator system 108 can also include booking APIs 124. Booking APIs 124 can provide an interface between the aggregator system 108 and each individual OTA system 110 and lodging system 112 for performing bookings, including reservations and payment. Booking APIs 124 allow the aggregator system 108 to communicate directly with each individual OTA system 110 and lodging system 112.

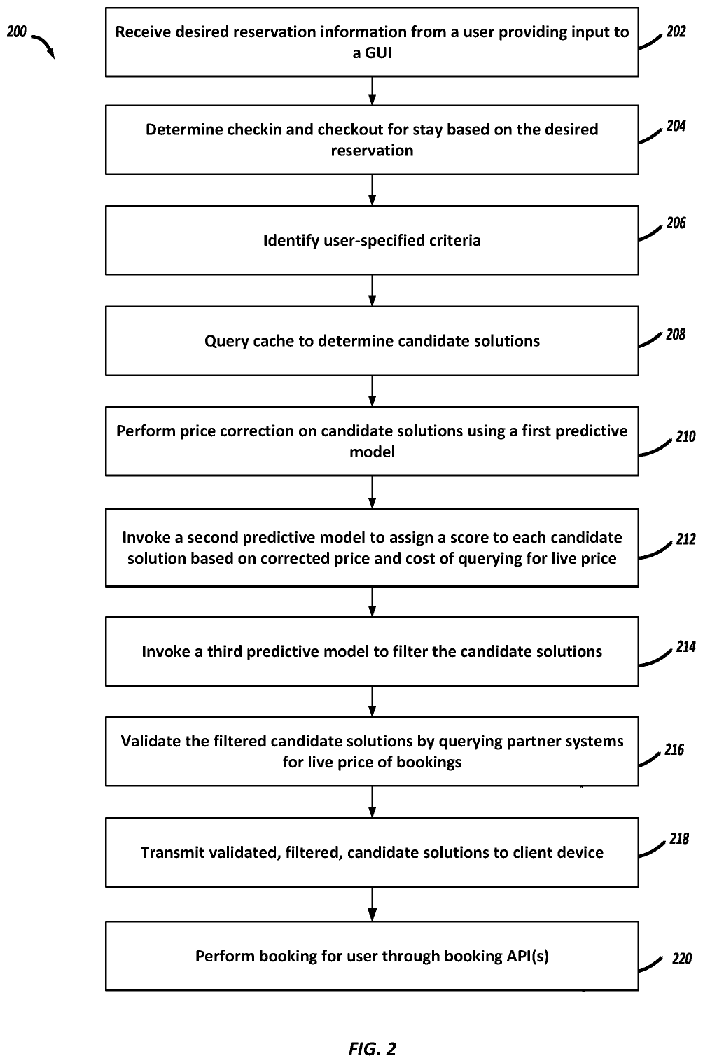

FIG. 2 is a flowchart showing an example process 200 for generating split bookings. In some implementations, process 200 is performed by booking management system 102 of FIG. 1. However, it will be understood that method 200 may be performed, for example, by any suitable system, environment, software, and hardware, or a combination thereof, as appropriate. In some instances, method 200 may be performed by a plurality of connected components or systems. Any suitable system(s), architecture(s), or application(s) can be used to perform the illustrated operations.

At 202, desired reservation information is received from a user providing input to a graphical user interface.

At 204, a length of stay can be determined based on the desired reservation using the user-provided input. The length of the stay can be used in determining how the split stay can be determined as far as how many days can be split and how many splits are possible. In embodiments, a maximum number of splits can be used, each split having a minimum number of nights, so as to not overly burden the user's movement or overly burden the computational resources.

At 206, a maximum number of contiguous bookings and a quality criteria can be determined from user-specified information. In some implementations, the quality criteria is determined based on an arrival date, a departure date, and a room quality. In some implementations, the maximum number of contiguous bookings is determined based on a length of each particular contiguous booking and a potential cost of each particular contiguous booking relative to a cost of a single booking. The user-specified information can also include an indication that the user would consider a split stay as an option for the reservation.

At 208, a cache (or other fast data store or database) is queried to determine candidate solutions that satisfy the quality criteria. Each candidate solution includes a number of contiguous bookings that is equal to or less than the maximum number of contiguous bookings. Because the queries are made from the cache, the candidate solutions can include very possible solution available from the cache.

At 210, a price and availability estimation and correction can be performed on the candidate solutions. The price correction can be a price update based on the values stored in the cache or historical database using a first predictive model configured to predict what the price will be. The first predictive model can estimate price and availability for each hotel and each room for the check-in and check-out dates using machine learning or other predictive intelligence.

At 212, a second predictive model is invoked to assign a score to each candidate solution based on the estimated, corrected price. Scoring can be done based on historic user behavior, other user's behavior, historic information, and other information using a predictive model or other machine learning. In some embodiments, the cost of querying (e.g., a partner system) for a live price can also be a factor in the score.

At 214, a third predictive model is invoked to filter the candidate solutions based on a score threshold. In some implementations, the first, second, and third predictive models are machine learning algorithms, and can be configured to predict specific patterns based on previously received training data.

At 216, the filtered candidate solutions are validated by querying partner systems for live price. By performing the broad searching for all solutions from the cache, and by using predictive models for price and availability estimation and correction, only a subset of the solutions are queried for live pricing. This reduction in the number of queries results in 1) fewer overall queries being made to partner/provider systems and 2) accurate solutions are provided to the user that meet user requirements. Optionally, the live pricing can be used to update the solutions. For example, the live pricing can indicate that a solution is no longer a good solution or does not meet user criteria for pricing or availability. The updated solutions can then be rescored using live pricing and availability information.

At 218, the validated, filtered, candidate solutions are provided to a client device for presentation and approval of the user. In some implementations, if the user approves, the booking management system can automatically reserve the bookings in accordance with the approved solution on behalf of the user.

At 220, the aggregation system 100 system can perform booking services for the user based on the user's confirmation of lodging reservations. In embodiments, the aggregation system 108 can coordinate booking for the user using booking APIs 124. For split stays, the aggregation system 100 can use a GUI to receive payment and other information from the user. The aggregation system 100 can then interface with the one or more booking APIs to enter reservation, user information, payment, and other information into provider systems. This way, the user 104 can enter the information once, and the aggregation system 100 can interface with one or more providers to complete the bookings for split stays on behalf of the user 104. This makes the user 104 experience better because the user does not have to enter information multiple times. The user experience is also enhanced because the aggregation system 100 can confirm bookings at multiple places for the user using APIs and the user does not have to interface with separate booking sites. This multi-booking functionality can lock in the reservations at multiple locations faster, thereby guaranteeing that the user will have the preferred accommodations at the offered prices.

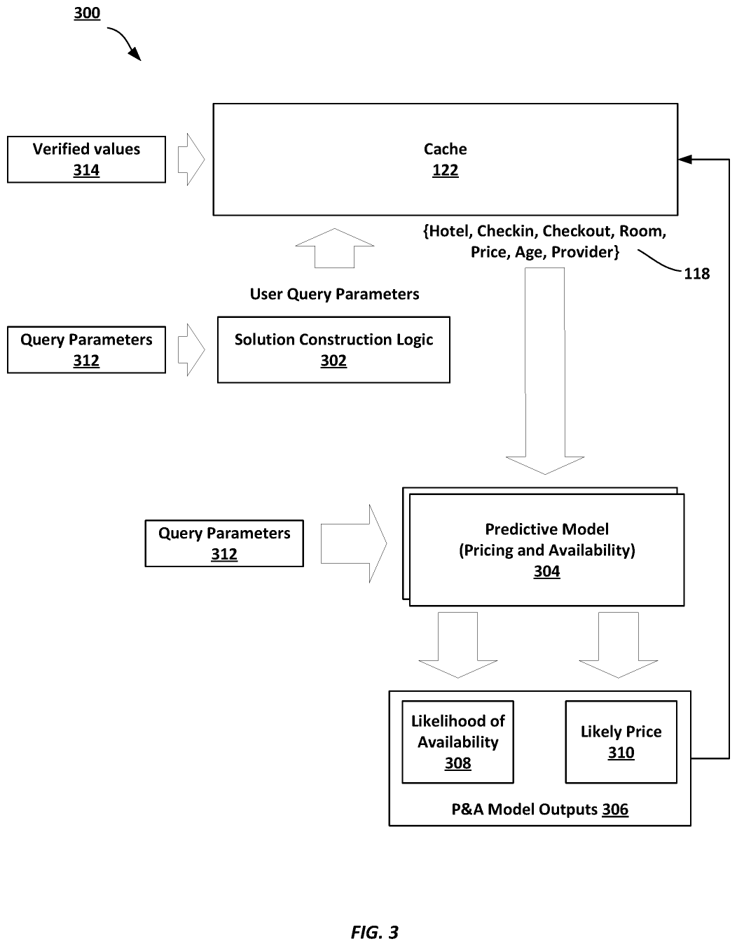

FIG. 3 is a schematic diagram of an example pricing and availability (P&A) prediction subsystem 300 for performing cache updates using predictive modeling in accordance with embodiments of the present disclosure. When a user queries the aggregation system for lodging, a solution construction logic 302 can start the query process by triggering an update of the cache key information 118 relevant to the user's query. The user's query can include a destination city or area within a city, check-in and check-out dates, hotel type or level, room type or level, lodging loyalty number or preferences, indication of split stay preferences, or other information. To be able to rely on the cache 122 as a source of valid information, the P&A prediction subsystem 300 can use a P&A prediction model 304 to output a likely price and a likelihood of availability of each hotel and each room in cache 122 for the user-specified dates. The solution construction logic 302, implemented in hardware, software, or a combination of hardware and software, can act as a controller or supervisor of the query process. Other logical elements can also be used for these processes, alone or in combination, without deviating from the scope of this disclosure.

The pricing and availability prediction subsystem 300 can include a P&A prediction model 304. The P&A prediction model 304 can be a trained and supervised machine learning model, such as a neural network. The supervised machine learning model can be trained using a large distribution of lodging sites, dates, prices, rooms, availability, booking trends, and other information. The training can also make use of live pricing and availability for verification of the machine learning hidden layer parameters, such as the weighting used by the hidden layer(s). An unsupervised machine learning model can also be used. For example, a machine learning model pre-trained for performing another task can be used for the P&A prediction model.

In some embodiments, the machine learning model can be selected based on the details of the user's query. For example, the P&A prediction subsystem 100 can select between an “on-season” model and an “off-season” model. The on-season model can be used for lodging queries for reservation dates that are considered “on-season” and the off-season model can be used for lodging queries for reservations dates that are considered “off-season.” A third “transition season” model can be used for dates that fall at transitions between on-season and off-season. Booking trends, pricing, and other information can be very different between on-season and off-season. The granularity of the models can be selected and trained as an implementation choice. The use of granular models can increase the accuracy and precision of the ML outputs 306 because errors associated with large outliers can be mitigated. A reduction in price and an increase in availability during the off-season can skew the price and availability trends during the on-season. By using two separate models, each model can be trained using data that does not include large outliers. In this way, the machine learning models more accurately predict pricing and availability and are not skewed one way or the other by large outliers in booking trends (e.g., pricing and availability trends) that can occur between on-season bookings and off-season bookings.

The output 306 of the P&A prediction model 304 outputs likely pricing 310 and availability information 308. The P&A prediction model 304 uses the cache key information 118 as inputs. In addition, the P&A prediction model 304 can use the query parameters 312 from the user's query, such as the length of the stay (i.e., check-in, check-out, and permissive flexibility indication) and other parameters. The P&A prediction model 304 can update the pricing and availability using a trained neural network. For example, depending on the age of the cache key information and from training data, the neural network can predict a likely price 310 and a likelihood of availability 308 for each hotel and each room in the hotel for the dates specified that is input into the P&A prediction model 304. The ML outputs 306 can be used to update the cache key information 118 for each corresponding cache key 118 in cache (or a new cache key can be created with an updated age and pricing). This updated cache key information 118 can be used to construct candidate solutions to the user's query.

The cache 122 can be updated with verified values for pricing and availability. For example, after live pricing and availability verification or after a room is booked, the cache 122 can be updated with verified values of cache key information 122, including an updated price and age of that information.

The updating of the cache 122 can be performed asynchronously or periodically. An advantage to performing the cache update periodically is that the timing of the cache updates can result in more frequent updates. Cache 122 can also be updated at non-peak hours by performing live pricing verification (e.g., in the middle of the night, when such queries to provider systems can be performed during times when resources are being underutilized). The periodic cache updates, however, would be performed on all entries in the cache, which could be expensive and still need live verification after a query is submitted. By performing cache updates after a user makes a query, the stay parameters specified by the user's query can be used to reduce the number of possible combinations (e.g., based on city, hotel type, room type, and dates). By reducing the number of candidate solutions based on user query information, the P&A predictive models 304 only need to operate on a smaller subset of all possible combinations in the cache 122, thereby reducing computational resources and reducing the amount of time to provide results. Further, since a cache update is performed for each user query, a large cross-section of the cache is updated with some frequency without having to perform large provider queries.

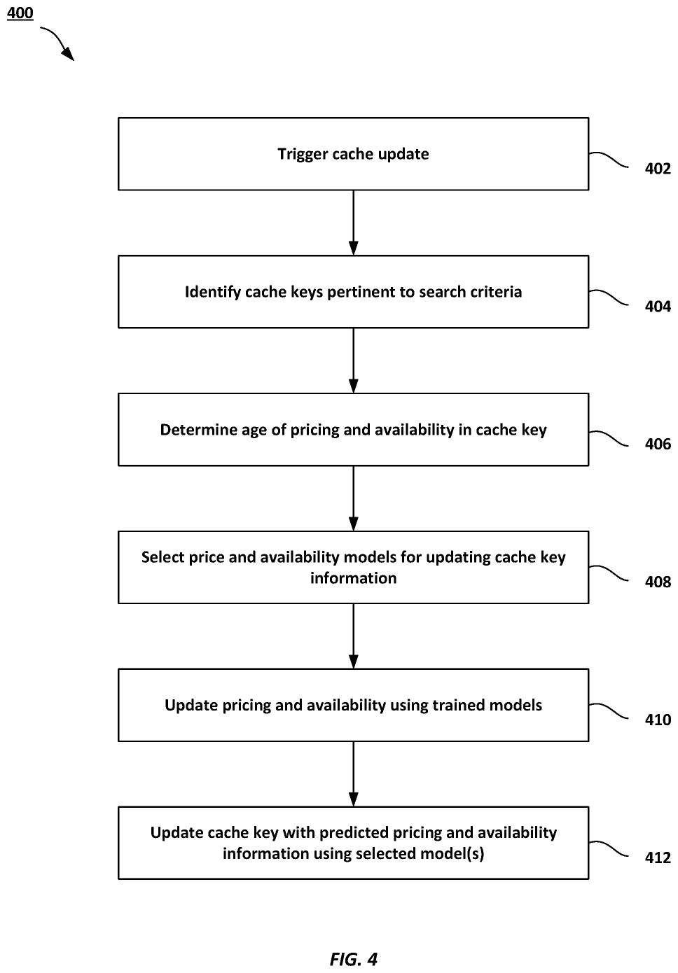

FIG. 4 is a process flow diagram 400 for performing cache updates using predictive modeling in accordance with embodiments of the present disclosure. A cache update can be triggered (402). The cache update can be triggered by a user making an inquiry for lodging reservations. The cache update can be triggered asynchronously, as described above. If the cache update is triggered by a user inquiry, then the query terms provided by the user can be used to identify cache keys pertinent to the user inquiry (404). The cache keys pertinent to the user's inquiry can be input into a P&A prediction model (410). The P&A prediction model can estimate an updated value for each price and availability for each pertinent cache key (412). A new cache key with updated information or an updated cache key can be stored in cache. The update includes an updated (estimated) price and availability and an updated age of the cache key information.

In embodiments, a subset of the pertinent cache keys are updated based on the age of the cache key (406). For example, for cache keys with ages that are newer than a predefined threshold amount of time, an update might not be necessary because the cache key information is considered fresh. Cache keys with ages older than a predefined threshold amount of time can be updated because they are considered stale or close to becoming stale. In embodiments, for cache key information, including very old cache key information, the P&A prediction model can take the age of the cache key into account when performing the estimated price and availability corrections.

In some embodiments, the information within the cache key can be used to select an appropriate or desired P&A prediction model (408). For example, the location information and the check-in and check-out dates from the user query can be used to select a prediction model that is trained for that location and those dates. The on-season/off-season prediction models are one example. Another example can be a first model for summer vacation times and another model for when school is in session. Other examples are within the scope of this disclosure.

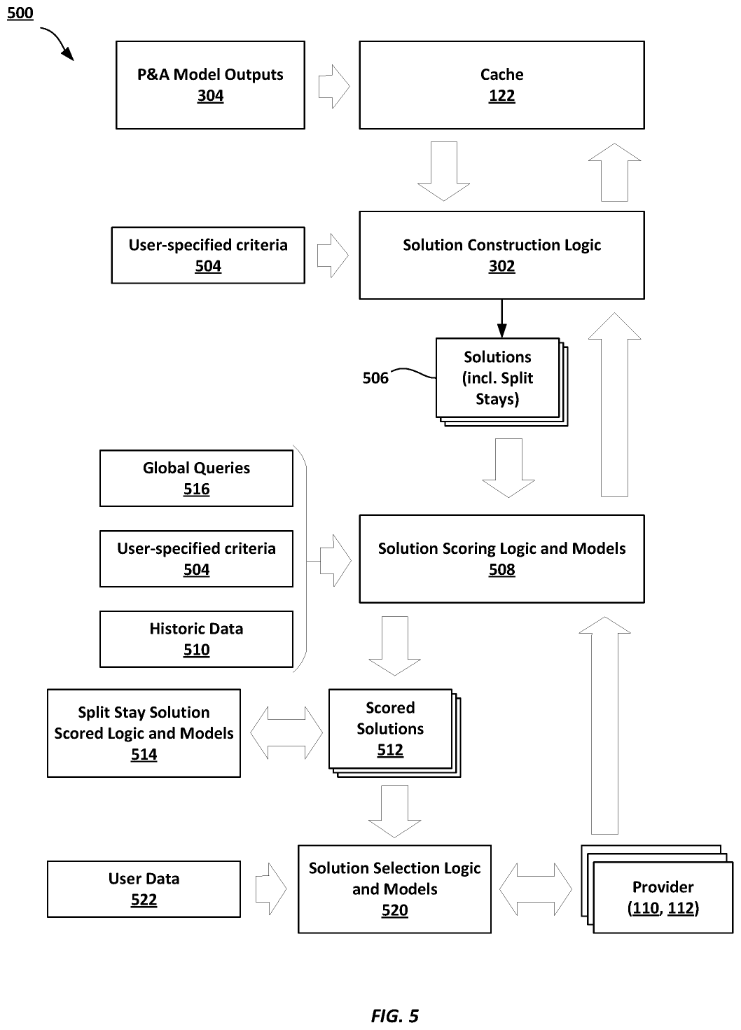

After the cache is updated using the P&A prediction models, the solution construction logic can begin constructing lodging solutions. FIG. 5 is a schematic diagram of an example subsystem 500 for constructing and scoring solutions in accordance with embodiments of the present disclosure. The solution construction logic 302 can perform a search in cache 122 for lodging solutions that match the user's query using query parameters 312 provided by the user. Solution construction logic 302 can be implemented using hardware, software, or a combination of hardware and software. The solution construction logic 302 can perform a broad search from cache 122 to construct a plurality of solutions that satisfy the user's query from the information stored in cache 122. In some embodiments, the solution construction logic 302 can construct all the solutions possible that satisfy the user's query from information stored in cache 122. The use of the cache 122 for searching for and construction solutions can be performed quickly and using fewer resources in comparison to performing queries to the providers that own the data.

As mentioned above, the cache 122 is updated using the ML outputs 304 from the cache update procedure discussed above. The solution construction logic 302 performs a search in cache 122 for solutions to the user's query. The solution construction logic 302 constructs solutions 506, which can include split stay solutions. The solution construction logic 302 can construct all possible solutions supported by the updated cache 122 relevant to the search query. The solution construction logic 302 can perform such a broad a search because the solution construction logic 302 queries the cache 122, instead of making queries to providers directly. The solution construction logic 302 can apply the estimated likelihood of availability 308 and the likely pricing 310 from the P&A predictive model outputs 306 from cache 122 to construct each solution 506.

A solution scoring logic and models 508, implemented by hardware, software, or a combination of hardware and software, can be used to score and rank each of the constructed solutions 506 to produce a set of scored solutions 512. For example, the solution scoring logic and models 508 can apply a threshold to identify and score a set of top candidate solutions from solution set 506, taking into account the potential user savings and a global per-provider query budget 516. This scoring relies on an analysis of the global population and specific user sensitivity to wide range of trade-offs.

For example, solution scoring logic and models 508 can use predictive models to determine one or more lodging solutions for the user based on user reservation history and preferences, larger population reservation history and preferences, user sensitivity to certain trade-offs to bring price down (price versus amenities or room type, etc.), global query budgets (e.g., the cost of performing live pricing verification by direct queries to providers), etc.

Solution selection logic and models 520 can decide which (and how many) solutions are good for the user conducting the search. For example, solution selection logic and models 520 can use a machine learning model that examines the individual user's context and criteria 504 and historic data 510 based on user data 522. This analysis facilitates a personalization of what the aggregation system 100 can show to the user. The models can use explicit preferences from user-entered information and inferred user preferences from historical information from users and similar users, such as past bookings. Other information that can be used for selecting the solutions for the user include loyalty to hotel brands, previously booked hotels, previous information about split stay selections, previous choices between trade-offs between pricing and other considerations, or different contexts for different legs of the stay (e.g. business vs. pleasure following a business trip).

Scoring can be a rating system, such as 1-10, where a 10 is highest. A threshold value can be used as a cut-off score to reduce the number of solutions to verify and present to the user. The scoring can be personalized, as mentioned before, so a high score for a user would reflect that user's preferences.

The solution selection logic and models 520 can confirm the selected solutions by performing live pricing and availability queries directly from identified providers 110, 112. The live pricing and availability verification can be made through API calls to each corresponding provider 110, 112 before presenting to the user to verify the pricing and availability. Because the pricing and availability of the solutions are based on estimated and corrected values from cache, real pricing and availability is confirmed prior to presenting the solutions to the user. The use of the cache 122 to reduce the number of possible solutions, however, has the advantage of only verifying live pricing and availability for a subset of possible solutions, as opposed to verifying the pricing and availability for all or a large number of solutions. The lower number of provider queries reduces costs and time to return results to the user.

Live pricing and availability can also be used to update the cache 122 so that cache keys have actual pricing and availability information. In addition, the live pricing and availability information can be used as training data to refine the predictive models used to update the cache.

In some embodiments, if a solution is not valid because the price is too high or the room is unavailable, that information is provided to the solution scoring logic and models 508 that can update the solutions as far as their scoring, and a new set of solutions can be identified that meet scoring criteria. It is possible that previously identified high-scoring solutions drop off and are substituted for other solutions.

In embodiments, a split stay solutions scoring logic and models 514 can be used to assemble split stay solutions. The split stay solutions can use user preferences and the scored solutions to construct a set of high-ranking split stay solutions for the user. These solutions are also personalized based on similar inputs as described above. The split stay solutions provide the user with the ability to save money on their total length stay by splitting the stay into more than one lodging option. In addition, a user can use split stays to stay at a preferred hotel for a period while it is available and switch to another hotel for the remainder of the time. In this way, the user's preferences for hotels can be at least partially met. This is of particular importance after live pricing and availability is verified because the high scoring options can still be presented to the user for a portion of the trip, while also presenting alternatives to the user that meet the user's pricing preferences and other considerations, such as room type, amenities, etc. Each portion of the split stay can be evaluated for a score in a similar manner as described above, and each portion should meet or exceed threshold scores for the user.

The use of cache 122 fundamentally supports the rapid, efficient, and thorough compilation of split stays, and the cache validation step also facilitates the accuracy of the pricing and availability. The split stay solution can involve the following process:

(1) The processor can enumerate all possible split stay combinations, given the user's context and the information available in cache. This is computationally inexpensive because the processor uses the information stored in cache, and cache memories by nature support efficient querying. Indeed, the cache engine could be chosen specifically to support efficient application of filters, predicates and constraints expected from a split stay use-case. The user's context contributes an initial set of conditions and constraints that define a broad “universe” of split stays. In this example, “user context” refers to any combination of current and historical attributes, preferences, behaviors or inferred/estimated renderings thereof. The user's attributes may include attributes specific to the individual user, or they may be specific to wider segments of users (e.g., all users in a city, state, country, etc.), or the attributes may simply be specific to all users observing a portion of the product (e.g., all users doing a hotel search on a specific brand of hotel or attending a specific conference). A simplified (non-limiting) example as to how the user's context would contribute constraints at this stage of the split-stay generation process would be if the user has landed on a hotel search results page after entering a destination and checkin/checkout dates, then the processor can use those parameters to restrict the set of allowable split stays to just the city or area they have expressed an interest in, over the dates they have entered. If, in another example, a user has clicked on a specific hotel out of a set of search results to retrieve reviews and more detail, the processor can narrow the geographic area for split-stay purposes to hotels close to the hotel of interest or to hotels of similar class or to hotels that other users have booked with the hotel of interest for previous split stays. If the user has applied a star rating filter to their search results, the processor can restrict split-stays to hotels of equal-or-better ratings. Other rules, such as availability, check-in/check-out date compatibility, and length-of-stay coverage would be enforced.

(2) There may be many valid and relevant split stays after this first stage of the process. Once all valid, relevant split stays have been enumerated, the processor can decide which of the split stays should be presented to the user, given their context, because presenting all options is impractical or unhelpful for the user. One example way to reduce the set of split stays and decide which subset to present to the user is to algorithmically rank-order the split stays and then show the top ranked items. Ranking can be based on how closely each split stay solution (e.g., both hotels collectively) satisfy the user's criteria.

This winnowing process is also a natural and compelling place to insert personalization algorithms, so as to enhance the relevance and attractiveness of the results that are shown to the user, given their context and preferences. Personalization may occur on some or all levels of different specificity, depending on the level of specificity of the information contained in the user's known context: personalize based on information that is available on all users (brand, acquisition channel), all the way down to attributes specific to the individual user, such as saved hotel chain preferences, or previous purchase price ranges. A winnowing process may also involve live-validation of candidate split stays, and/or, may factor in the downstream cost of validating candidate stays later, if the use case involves or requires such live-validation of the final split stays that will be displayed to the user. This is where per-provider query budgets and constraints may enter and be optimized. For example, if a business has a strict limit on how many times per day they may query a given provider, and for a given user's specific context that provider is less likely to have available inventory, then the process may opt to NOT query that provider even though they may be a participant in an otherwise compelling candidate split-stay. In this scenario, the processor may only query this provider if historically they offer good prices and availability given the age of the cache estimate and the specifics of the split-stay. One may also collect statistics or data around the discrepancy between estimated and actual price and availability, and using these data, perform algorithmic joint-optimization of the provider querying process, taking into account the expected impact on the selection of split stays.

(3) If necessary, the process can validate the top split stays by querying the relevant providers to confirm prices and availability. Using live data, the processor can apply an algorithm to select the final set of split-stays. This algorithm may be similar to the algorithm used in step (2), or, it may for example simply involve removing any options that do not have availability (invalid options), or that would be strictly more expensive than simpler or more convenient options. Finally, the presentation of the final split stay options may be chosen depending on the user's context. For example, if the context is one in which more than a handful of options are to be displayed, then a user experience that makes comparison among the options along specific relevant dimensions easier could be pursued.

The solutions, including split stay solutions, can be presented to the user on an interactive GUI. The user can then select a solution to make a reservation and book the room(s). The aggregation system 100 can include APIs that allow the user to enter information directly into the aggregation system client interface 114 to make bookings and payments through the aggregation system 100 without having to go directly to the provider 110, 112. This way, the user can make more than one booking (e.g., for split stays) using a single interface in one session.

After the user books a lodging (or if they do not book lodging), the predictive models used can be updated using information about the user's activity. The cache 122 can also be updated if the user books one or more hotels. The cache 122 can reflect a change in availability for the room(s) booked by the user.

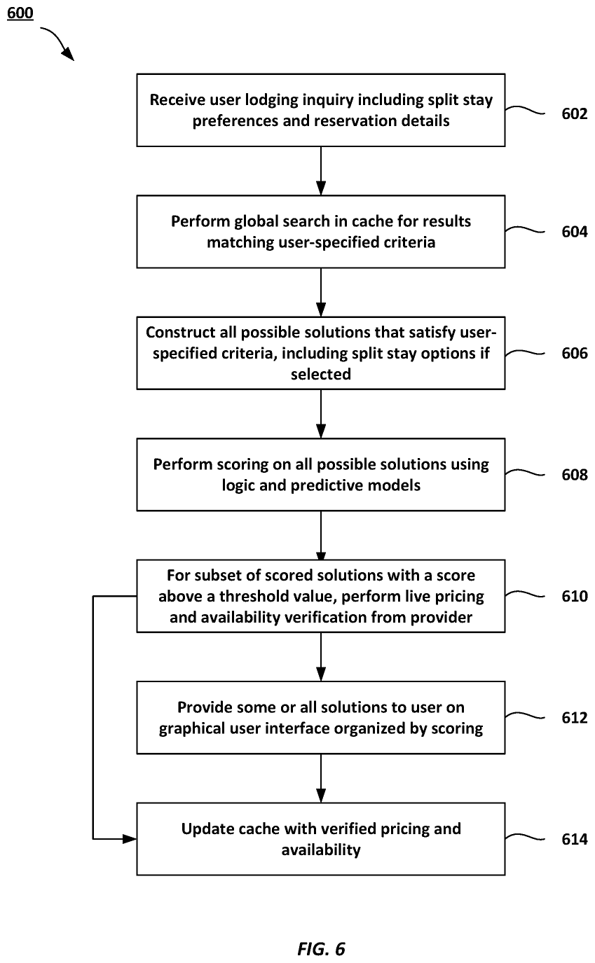

FIG. 6 is a process flow diagram 600 for constructing and scoring solutions and presenting solutions to a user in accordance with embodiments of the present disclosure. The aggregation system can receive through a GUI a lodging inquiry from a user. In some implementations, the lodging inquiry includes an indication that a split stay is an acceptable result (602). The solution construction logic performs a global search in the now updated cache for results matching the user-specified criteria (604). The solution construction logic constructs all possible solutions (or as many possible solutions as is feasible) including split stay solutions that satisfy the user-specified criteria (606). A solution scoring logic can perform scoring on each of the solutions constructed by the solution construction logic (608). For a subset of scored solutions having a score above a custom threshold value for the user, a solution selection logic performs live pricing and availability verification by querying providers directly for that information (610). The live pricing and availability information can be used to update the cache (614). The solutions can be provided to the user (612). If the user books one or more rooms, the availability information can be updated in the cache for the room(s) booked (614).

Because the techniques described herein can provide lodging solutions, including split stay solutions, quickly and with reduced costs, one implementation scenario can include using the techniques described herein for planning larger itineraries for the user. For example, a user traveling to a region or country for a holiday can use the techniques described herein to book multiple lodging stays at different cities in the same or similar manner as a split stay. The itineraries can include a lodging solution in each city (analogous to a split stay in a single city), and can rank the itineraries using the scoring logic (analogous to scoring each lodging solution). The system can then perform booking using APIs.

In some embodiments, the system can also present and book excursions and outings for each city, if APIs are available. The identification and selection of excursions and outings can be personalized to the user in the same way (or similar way) that the lodging solutions are personalized. That is, based on user histories, preferences, specified criteria, other users' behavior and patterns, special interests, popular activities in each city, etc. If APIs are not available for excursions and outings, the system can provide recommendations for booking options, such as business names with high rankings and web links or other forms of contact information.

In this way, a traveler can use the split stay functionality described herein to plan out entire itineraries for multiple cities, and also book reservations for entire itineraries using a single GUI.

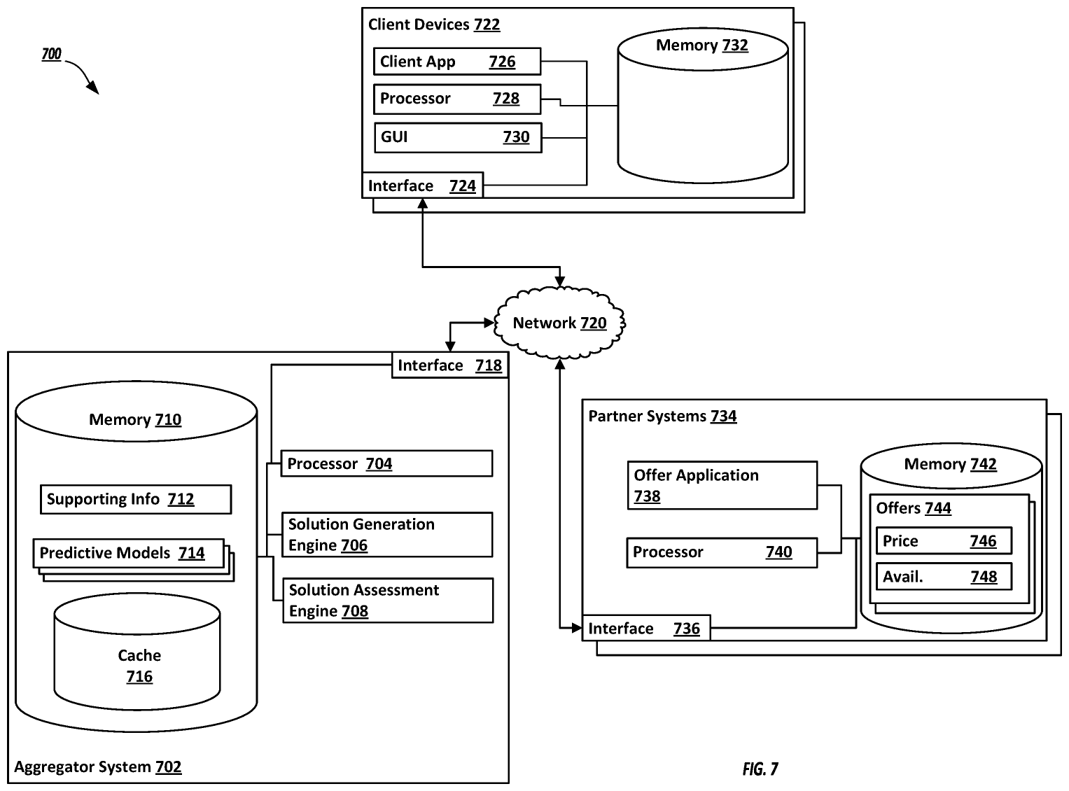

FIG. 7 is an example architecture for a system 700 for generating split stays automatically. FIG. 7 includes a booking management system 702, one or more client devices 722, and one or more partner systems 734, which communicate using a network 720.

Booking management system 702 includes a processor 704, a solution generation engine 706, a solution assessment engine 708, and a memory 710 which stores, among other things, user information 712, one or more predictive models 714, and a historical price database 716. Booking management system 702 further includes at least one interface 718.

One or more processor(s) 704 are included in the booking management system 702. Although illustrated as a single processor 704 in FIG. 7, multiple processors can be used according to particular needs, desires, or particular implementations of the system 700. Each processor 704 can be a central processing unit (CPU), an application specific integrated circuit (ASIC), a field-programmable gate array (FPGA), or another suitable component. Generally, the processor 704 executes instructions and manipulates data to perform the operations of the booking management system 702. Specifically, the processor 704 executes the algorithms and operations described in the illustrated figures, as well as the various software modules and functionality, including the functionality for sending communications to and receiving transmissions from the partner systems 734, the client devices 722, as well as to other devices and systems. Each processor 704 can have a single or multiple core, with each core available to host and execute an individual processing thread. Further, the number of, types of, and particular processors 704 used to execute the operations described herein can be dynamically determined based on a number of requests, interactions, and operations associated with the booking management system 702.

The solution generation engine 706 can be a software application that receives desired booking information from the user (e.g., arrival date, departure date, desired quality of room, etc.) and generates potential solutions. A solution can be either a single stay (e.g., one hotel room for the duration of the desired stay) or a split stay (e.g., multiple contiguous bookings covering multiple rooms, multiple hotels, or the same room from different providers). The solution generation engine 706 generally queries a historical price database 716, which stores historical price or rate and availability data for a large volume of hotels in a relatively low cost (query cost) storage solution. Historical price database 716 can be store within memory 710.

Solution assessment engine 708 performs operations for assessing the potential solutions generated by solution generation engine 706. Solution assessment engine 708 can call one or more predictive models 714 from memory 710, as well as user info 712, and information received from the client devices 722 in order to assess, score, or otherwise discriminate between potential solutions generated by solution generation engine 706. Solution assessment engine 708 can further provide price correction/updating based on outputs from one or more predictive models 714.

Predictive models 714 can be machine learning models that are trained to generate a predictive output based on a corpus of training data. In some implementations, the predictive model 714 is a deep learning model that employs multiple layers of models to generate an output for a received input. A deep neural network is a deep machine learning model that includes an output layer and one or more hidden layers that each apply a non-linear transformation to a received input to generate an output. In some cases, the neural network may be a recurrent neural network. A recurrent neural network is a neural network that receives an input sequence and generates an output sequence from the input sequence. In particular, a recurrent neural network uses some or all of the internal state of the network after processing a previous input in the input sequence to generate an output from the current input in the input sequence. In some other implementations, the predictive model 714 is a convolutional neural network. In some implementations, the predictive model 714 is an ensemble of models that may include all or a subset of the architectures described above.

In some implementations, the predictive model 714 can be a feedforward auto-encoder neural network. For example, the predictive model 714 can be a three-layer auto-encoder neural network. The predictive model 714 may include an input layer, a hidden layer, and an output layer. In some implementations, the neural network has no recurrent connections between layers. Each layer of the neural network may be fully connected to the next, e.g., there may be no pruning between the layers. The neural network may include an optimizer for training the network and computing updated layer weights, such as, but not limited to, ADAM, Adagrad, Adadelta, RMSprop, Stochastic Gradient Descent (SGD), or SGD with momentum. In some implementations, the neural network may apply a mathematical transformation, e.g., a convolutional transformation or factor analysis to input data prior to feeding the input data to the network.

In some implementations, the predictive model 714 can be a supervised model. For example, for each input provided to the model during training, the predictive model 714 can be instructed as to what the correct output should be. The predictive model 714 can use batch training, e.g., training on a subset of examples before each adjustment, instead of the entire available set of examples. This may improve the efficiency of training the model and may improve the generalizability of the model. The predictive model 714 may use folded cross-validation. For example, some fraction (the “fold”) of the data available for training can be left out of training and used in a later testing phase to confirm how well the model generalizes. In some implementations, the predictive model 714 may be an unsupervised model. For example, the model may adjust itself based on mathematical distances between examples rather than based on feedback on its performance.

The predictive model 714 can be, for example, a deep-learning neural network or a “very” deep learning neural network. For example, the predictive model 714 can be a convolutional neural network. The predictive model 714 can be a recurrent network. The predictive model 714 can have residual connections or dense connections. The predictive model 714 can be an ensemble of all or a subset of these architectures. The model may be trained in a supervised or unsupervised manner. In some examples, the model may be trained in an adversarial manner. In some examples, the model may be trained using multiple objectives, loss functions or tasks.

Memory 710 of the booking management system 702 can represent a single memory or multiple memories. The memory 710 can include any memory or database module and can take the form of volatile or non-volatile memory including, without limitation, magnetic media, optical media, random access memory (RAM), read-only memory (ROM), removable media, or any other suitable local or remote memory component. The memory 710 can store various objects or data, including predictive models 714, user and/or user information 712, administrative settings, password information, caches, applications, backup data, repositories storing business and/or dynamic information, and any other appropriate information associated with the booking management system 702, including any parameters, variables, algorithms, instructions, rules, constraints, or references thereto. Additionally, the memory 710 can store any other appropriate data, such as VPN applications, firmware logs and policies, firewall policies, a security or access log, print or other reporting files, as well as others. While illustrated within the booking management system 702, memory 710 or any portion thereof, including some or all of the particular illustrated components, can be located, in some instances, remote from the booking management system 702, including as a cloud application or repository, or as a separate cloud application or repository when the booking management system 702 itself is a cloud-based system. In some examples, the data stored in memory 710 can be accessible, for example, via network 720, and can be obtained by particular applications or functionality of the booking management system 702. As illustrated and previously described, memory 710 includes the historical price database 716, as well as instructions for executing the solution generation engine 706, the solution assessment engine 708, the interface 718, and other applications and functionality.

The interface 718 is used by the booking management system 702 for communicating with other systems in a distributed environment—including within the system 700—connected to the network 720, including client devices 722, partner systems 734, and other systems communicably coupled to the booking management system 702 and/or network 720. Generally, the interface 718 comprises logic encoded in software and/or hardware in a suitable combination and operable to communicate with the network 720 and other components. More specifically, the interface 718 can comprise software supporting one or more communication protocols associated with communications, such that the network 720 and/or interface's hardware is operable to communicate physical signals within and outside of the illustrated system 700. Still further, the interface 718 can allow the booking management system 702 to communicate with the client devices 722 and/or the partner systems 734, and other systems to perform the operations described herein.

Network 720 facilitates wireless or wireline communications between the components of the system 700 (e.g., between the booking management system 702, the client device(s) 722, or the partner systems 734, etc.), as well as with any other local or remote computers, such as additional mobile devices, clients, servers, or other devices communicably coupled to network 720, including those not illustrated in FIG. 7. In the illustrated environment, the network 720 is depicted as a single network, but can be comprised of more than one network without departing from the scope of this disclosure, so long as at least a portion of the network 720 can facilitate communications between senders and recipients. In some instances, one or more of the illustrated components (e.g., the memory 710, the solution generation engine 706, etc.) can be included within or deployed to network 720, or a portion thereof, as one or more cloud-based services or operations. The network 720 can be all or a portion of an enterprise or secured network, while in another instance, at least a portion of the network 720 can represent a connection to the Internet. In some instances, a portion of the network 720 can be a virtual private network (VPN). Further, all or a portion of the network 720 can comprise either a wireline or wireless link. Example wireless links can include 802.11a/b/g/n/ac, 802.20, WiMax, LTE, and/or any other appropriate wireless link. In other words, the network 720 encompasses any internal or external network, networks, sub-networks, or combination thereof operable to facilitate communications between various computing components inside and outside the illustrated system 700. The network 720 can communicate, for example, Internet Protocol (IP) packets, Frame Relay frames, Asynchronous Transfer Mode (ATM) cells, voice, video, data, and other suitable information between network addresses. The network 720 can also include one or more local area networks (LANs), radio access networks (RANs), metropolitan area networks (MANs), wide area networks (WANs), all or a portion of the Internet, and/or any other communication system or systems at one or more locations.

Client devices 722 include a client application 726, one or more processors 728, a graphical user interface (GUI) 730, an interface 724, and a memory 732. In general, the client devices 722 act as a terminal, or portal for the user to interact within the system 700, and can be a mobile device (e.g., cell phone, tablet, etc.) or a fixed device (e.g., register, desktop computer, etc.).

Client application 726 generally allows the user to input desired bookings or search parameters, and interacts with booking management system 702 in order to provide results for display to the user. Processor 728 can be similar to, or different from processor 704 as described above. Similarly, memory 732 can be different from, or similar to, memory 710 as described above.

GUI 730 of the client device 722 interfaces with at least a portion of the system 700 for any suitable purpose, including generating a visual representation of any particular digital client application 726 and/or the content associated with any components of the client device 722 or booking management system 702. In particular, the GUI 730 can be used to present results of a digital application or query, including providing one or more booking solutions, as well as to otherwise interact and present information associated with one or more applications. GUI 730 can also be used to view and interact with various web pages, applications, and web services located local or external to the client device 722. Generally, the GUI 730 provides the user with an efficient and user-friendly presentation of data provided by or communicated within the system. The GUI 730 can comprise a plurality of customizable frames or views having interactive fields, pull-down lists, and buttons operated by the user. In general, the GUI 730 is often configurable, supports a combination of tables and graphs (bar, line, pie, status dials, etc.), and is able to build real-time portals, application windows, and presentations. Therefore, the GUI 730 contemplates any suitable graphical user interface, such as a combination of a generic web browser, a web-enable application, intelligent engine, and command line interface (CLI) that processes information in the platform and efficiently presents the results to the user visually.

One or more partner systems 734 provide offers for bookings, generally publishing availability, pricing, and quality for one or more hotel rooms. The partner system 734 include a processor 740, which can be similar to or different from processor 704 as described above, as well as a memory 742 that stores one or more offers 744, detailing price 746, and availability 748 for one or more bookings.

The offer application 738 generally responds to queries from the booking management system 702, providing updates price 746 information or availability information 748, and manages booking requests from the booking management system 702. In some implementations, the partner system 734 can determine a profit sharing ratio between the booking management system 702 and the partner system 734 based on a look-to-book ratio, incentivizing the booking management system 702 to minimize superfluous queries.

The preceding figures and accompanying description illustrate example processes and computer-implementable techniques. However, system 700 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, the described systems and flows may use processes and/or components with or performing additional operations, fewer operations, and/or different operations, so long as the methods and systems remain appropriate.

In other words, although this disclosure has been described in terms of certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A method for booking lodging location reservations, the method comprising:
receiving, at a booking management system and from a user providing input to a graphical user interface, desired lodging reservation information;
updating information stored in cache using a predictive machine learning model based, at least in part, on a portion of the received desired lodging reservation information;
performing a search in the cache for split stay solutions to the received desired reservation information;
from results of the search of the cache, constructing a plurality of split stay solutions available in the cache that satisfy the received desired reservation information;
determining a numeric score for individual split stay solutions using a scoring machine learning model that considers a preference of the user, the scoring machine learning model configured to weigh search context data and historical data associated with the user;
identifying a subset of split stay solutions based on comparing the numeric score of the individual split stay solutions against a threshold value, wherein the subset of split stay solutions comprises split stay solutions that have a numeric score above the threshold value;
performing live pricing and availability verification for the subset of split stay solutions by querying a provider corresponding to each of the subset of split stay solutions; and
presenting the subset of split stay solutions to the user with the verified pricing and availability information.

2. The method of claim 1, wherein the portion of the received desired reservation information comprises at least a location, a check in date, and a check out date.

3. The method of claim 1, wherein updating the information stored in cache using the predictive machine learning model comprises:
inputting a lodging location, a room, a check-in time, a check-out time, a price, and an age of the price into the predictive machine learning model;
processing the lodging location, the room, the check-in time, the check-out time, the price, and the age of the price using the predictive machine learning model; and
receiving an output from the predictive machine learning model comprising an estimated corrected value for price and an estimated likelihood of availability for each room of each lodging location for the check-in time and the check-out time based, at least in part, on the age of the price.

4. The method of claim 1, wherein determining the numeric score for the individual split stay solutions using the scoring machine learning model comprises:
inputting, into the scoring machine learning model, the split stay solutions constructed from the cache and one or more of user-specified reservation criteria, historic preferences and historic booking data for the user, and global query information;
processing the split stay solutions constructed from cache using the scoring machine learning model to derive a numeric score for the individual split stay solutions representative of one or more of the user-specified reservation criteria, the historic preferences and the historic booking data for the user, and the global query information; and
a receiving, as output from the scoring machine learning model, the numeric score for the individual split stay solutions personalized to the user based on the processing of the split stay solutions constructed from cache by the scoring machine learning model.

5. The method of claim 4, wherein the global query information comprises one or more of global population trends for booking similar lodging locations and rooms and global pricing for performing provider verification and queries.

6. The method of claim 1, comprising deriving the threshold value based on one or more of user-specified reservation criteria and historic preferences and historic booking data for the user.

7. The method of claim 1, wherein performing pricing and availability verification for the subset of split stay solutions by querying a provider corresponding to each of the subset of split stay solutions comprises performing an application programming interface (API) call to each provider of a split stay solution in the subset of split stay solutions to verify the price and availability of the split stay solution in the subset of split stay solutions.

8. The method of claim 1, further comprising, after performing live pricing and availability verification for the subset of split stay solutions, updating the cache with the live pricing and availability of each lodging location and room for the subset of split stay solutions.

9. The method of claim 1, wherein constructing the plurality of split stay solutions available in the cache that satisfy the received desired lodging reservation information comprises:
identifying, from cache, a plurality of lodging locations that satisfy the received desired reservation information,
determining that a first lodging location can satisfy a portion of the received desired reservation information for a first period of time,
determining that a second lodging location can satisfy a portion of the received desired reservation information for a second period of time, the second period of time adjacent and not overlapping the first period of time, the first period of time and the second period of time less than or equal to a duration of a stay based on the received desired lodging reservation information,
determining that the first lodging location and the second lodging location result in a monetary savings for the user, and
constructing a split stay solution that satisfies the received desired lodging reservation information that includes both the first lodging location for the first period of time and the second lodging location for the second period of time;
wherein performing the live pricing and availability verification for the subset of split stay solutions by querying a provider corresponding to each of the subset of split stay solutions comprises:
performing a first live query to the first lodging location to validate pricing and availability for the first period of time, and
performing a second live query to the second lodging location to validate pricing and availability for the second period of time; and
updating the cache with the pricing and availability of each of the first lodging location for the first period of time and the second lodging location for the second period of time.

10. The method of claim 1, further comprising:
receiving an indication from the user to book a split stay between two or more lodging locations;
accessing an application programming interface (API) for each of the two or more lodging locations; and
booking each stay for the two or more lodging locations for the user using the API corresponding to each lodging location.

11. At least one non-transitory, computer-readable medium for storing instructions for booking lodging location reservations, the instructions, when executed by one or more hardware processors, cause the one or more hardware processors to execute operations comprising:
receiving, at a booking management system and from a user providing input to a graphical user interface, desired lodging reservation information;
updating information stored in cache using a predictive machine learning model based, at least in part, on a portion of the received desired reservation information;
performing a search in the cache for split stay solutions to the received desired reservation information;
from results of the search of the cache, constructing a plurality of split stay solutions available in the cache that satisfy the received desired reservation information;
determining a numeric score for individual split stay solutions using a scoring machine learning model that considers a preference of the user, the scoring machine learning model configured to weigh search context data and historical data associated with user;
identifying a subset of split stay solutions based on comparing the score of the individual split stay solutions against a threshold value, wherein the subset of split stay solutions comprises split stay solutions that have a numeric score above the threshold value;
performing live pricing and availability verification for the subset of split stay solutions by querying a provider corresponding to each of the subset of split stay solutions; and
presenting the subset of split stay solutions to the user with the verified pricing and availability information.

12. The at least one non-transitory, computer-readable medium of claim 11, wherein the portion of the received desired reservation information comprises at least a location, a check in date, and a check out date.

13. The at least one non-transitory, computer-readable medium of claim 11, wherein updating the information stored in cache using the predictive machine learning model comprises:
inputting a lodging location, a room, a check-in time, a check-out time, a price, and an age of the price into the predictive machine learning model;
processing the lodging location, the room, the check-in time, the check-out time, the price, and the age of the price using the price and availability predictive machine learning model; and
receiving an output from the predictive machine learning model comprising an estimated corrected value for price and an estimated likelihood of availability for each room of each lodging location for the check-in time and check-out time based, at least in part, on the age of the price.

14. The at least one non-transitory, computer-readable medium of claim 11, wherein determining a numeric score for the individual split stay solutions using a scoring machine learning model comprises:
inputting, into the scoring machine learning model, the split stay solutions constructed from the cache and one or more of user-specified reservation criteria, historic preferences and historic booking data for the user, and global query information;
processing the split stay solutions constructed from cache using the scoring machine learning model to derive a numeric score for the individual split stay solutions representative of one or more of the user-specified reservation criteria, the historic preferences and the historic booking data for the user, and the global query information; and
a receiving, as output from the scoring machine learning model, the numeric score for the individual split stay solutions personalized to the user based on the processing of the split stay solutions constructed from cache by the scoring machine learning model.

15. The at least one non-transitory, computer-readable medium of claim 14, wherein the global query information comprises one or more of global population trends for booking similar lodging locations and rooms and global pricing for performing provider verification and queries.

16. The at least one non-transitory, computer-readable medium of claim 11, the operations further comprising deriving the threshold value based on one or more of user-specified reservation criteria and historic preferences and historic booking data for the user.

17. The at least one non-transitory, computer-readable medium of claim 11, wherein performing pricing and availability verification for the subset of split stay solutions by querying a provider corresponding to each of the subset of split stay solutions comprises performing an application programming interface (API) call to each provider of a split stay solution in the subset of split stay solutions to verify the price and availability of the split stay solution in the subset of split stay solutions.

18. The at least one non-transitory, computer-readable medium of claim 11, further comprising, after performing live pricing and availability verification for the subset of split stay solutions, updating the cache with the live pricing and availability of each lodging location and room for the subset of split stay solutions.

19. The at least one non-transitory, computer-readable medium of claim 11, wherein constructing the plurality of split stay solutions available in the cache that satisfy the received desired lodging reservation information comprises:
identifying, from cache, a plurality of lodging locations that satisfy the received desired reservation information,
determining that a first lodging location can satisfy a portion of the received desired reservation information for a first period of time,
determining that a second lodging location can satisfy a portion of the received desired reservation information for a second period of time, the second period of time adjacent and not overlapping the first period of time, the first period of time and the second period of time less than or equal to a duration of a stay based on the received desired lodging reservation information,
determining that the first lodging location and the second lodging location result in a monetary savings for the user, and
constructing a solution that satisfies the received desired lodging reservation information that includes both the first lodging location for the first period of time and the second lodging location for the second period of time;
wherein performing the live pricing and availability verification for the subset of split stay solutions by querying a provider corresponding to each of the subset of split stay solutions comprises:
performing a first live query to the first lodging location to validate pricing and availability for the first period of time, and
performing a second live query to the second lodging location to validate pricing and availability for the second period of time; and
updating the cache with the pricing and availability of each of the first lodging location for the first period of time and the second lodging location for the second period of time.

20. The at least one non-transitory, computer-readable medium of claim 11, the operations further comprising:
receiving an indication from the user to book a split stay between two or more lodging locations;
accessing an application programming interface (API) for each of the two or more lodging locations;
booking each stay for the two or more lodging locations for the user using the API corresponding to each lodging location.
